(19) United States
(12) Patent Application Publication
(10) Pub. No.: US 2010/0320797 A1
(43) Pub. Date: Dec. 23, 2010

(54) Molding for sealing a motor vehicle windshield with a cowl panel

(75) Inventor: Timothy J. Schlater, Dayton, OH (US)

Correspondence Address: Alan F. Meckstroth;JACOX, MECKSTROTH & JEMKINS, Suite 2, 2310 Far Hills Building, Dayton, OH, 45419-1575, US

(73) Assignee: Creative Extruded Products, Inc.

(21) Appl. No.: 12/456,778

(22) Filed: Jun. 23, 2009

(51) Int. Cl. B60J 10/02

(52) U.S. Cl. 296/93

(57) ABSTRACT

A molding is extruded of plastics materials and includes a first body portion adhesively attached to a bottom edge portion of a motor vehicle windshield and a second body portion defining a cavity which receives a projecting dart portion of a removable cowl panel located adjacent the windshield. The molding includes a co-extruded flexible tooth portion having a durometer different from the durometer of the first and second body portions. The tooth portion projects into the cavity to retain the dart portion of the cowl panel, but flexes downwardly when the dart portion is inserted into the cavity and flexes upwardly when the dart portion is pulled or peeled upwardly from the cavity when removing the cowl panel. The first body portion may extend around the edge portion of the windshield or may be attached to only an inner surface and an edge surface of the windshield.

### BACKGROUND OF THE INVENTION

The present invention relates to a molding of extruded plastics materials and which forms a seal between the lower edge portion of a motor vehicle windshield and a removable cowl panel which is commonly molded of a rigid plastics material and is located adjacent the bottom edge of the windshield. One form of such molding is disclosed in U.S. Pat. No. 6,769,700, the disclosure of which is herein incorporated by reference. In this type of molding when the molding and cowl panel extends across the full width of the windshield, it is sometimes necessary to remove the cowl panel in order to obtain access to the area below the cowl panel where equipment, such as an air filter, may be located in order to clean or replace the filter. Thus it has been found desirable to provide for conveniently and easily installing the cowl panel into the molding with low insertion forces and with the cowl panel, positively retained, but also provide for conveniently and easily removing the cowl panel without requiring a substantially pulling or lifting force which may damage the cowl panel and/or molding. If the cowl panel is damaged, a new cowl panel must be reinstalled, and if the molding is damaged, the windshield must be removed and replaced with a new molding attached to the bottom edge portion of the windshield.

### SUMMARY OF THE INVENTION

The present invention is directed to an improved molding for connecting and forming a seal between the lower edge portion of a motor vehicle windshield and a removable cowl panel located adjacent the lower edge portion of the windshield. The molding of the invention provides for quickly and conveniently installing a cowl panel after the molding has been pre-assembled onto a windshield which is then installed on a motor vehicle body so that the molding positively retains the cowl panel. The molding further provides for conveniently and quickly removing the cowl panel with a predetermined force so that neither the cowl panel nor the molding is damaged. In accordance with the illustrated embodiments of the molding, the one-piece molding is extruded of a plastics material and includes a first portion which is preassembled by adhesive to the lower edge portion of the windshield and a second portion which defines a longitudinally extending cavity for receiving a projecting dart portion of a cowl panel preferably molded of a rigid plastics material. The molding of the invention includes a flexible tooth portion which projects into the cavity to retain a surface on the dart portion of the cowl panel and to interlock the cowl panel to the windshield. The tooth portion is flexible between a downwardly projecting position in response to inserting the dart portion into the cavity and an upwardly projecting position in response to removing the cowl panel when the dart portion is pulled from the cavity. The tooth portion is co-extruded with a different durometer and is substantially softer than the more rigid plastics material attached to the windshield and forming the cavity. In one embodiment, the molding extends around the edge portion of the windshield, and the tooth portion is co-extruded with the first portion. In another embodiment, the molding is adhesively attached to an inner surface and an edge surface of the windshield, and the tooth portion is co-extruded with a softer cap portion having a top surface generally flush with the top surface of the cowl panel.

Other features and advantages of the invention will be apparent from the following description, the accompanying drawings and the appended claims.

### BRIEF DESCRIPTION OF THE DRAWINGS

FIG. 1 is an enlarged vertical section through a lower edge portion of a motor vehicle windshield and an extruded molding constructed in accordance with the invention and forming a seal with an edge portion of a cowl panel;

FIG. 2 is a fragmentary section of the molding shown in FIG. 1 and illustrating the cowl panel being inserted into the molding;

FIG. 3 is a fragmentary section similar to FIG. 2 and illustrating the cowl panel being removed from the molding; and

FIG. 4 shows another enlarged embodiment of a molding constructed in accordance with the invention and also forming a seal between the lower edge portion of a windshield and a cowl panel similar to the embodiment shown in FIGS. 1-3.

### DESCRIPTION OF THE ILLUSTRATED EMBODIMENTS

A motor vehicle glass windshield 10 has an outer surface 12 and a parallel inner surface 14 which are connected by a perpendicular edge surface 16. A lower edge portion 18 of the windshield extends across the width of the motor vehicle and receives a molding 20 extruded of a generally rigid plastics material and a co-extruded softer plastics material.

The molding 20 includes a first body portion 22 which has a C-shaped or channel cross-sectional configuration and receives the lower edge portion 18 of the windshield 10. Preferably, the first portion 22 is extruded of a generally rigid plastics material such as a rigid polyvinylchloride (PVC) or rigid polypropylene and is attached to the edge portion 18 of the windshield by a suitable adhesive 24 such as a polyurethane adhesive 24. The first portion 22 includes an outerflange portion 26 which contacts the outer surface 12 of the windshield and an inner flange portion 28 which contacts the inner surface 14 of the windshield. The flange portions 26 and 28 are integrally connected by a web portion 32 which is attached to the edge surface 16 of the windshield 10 by the adhesive 24. The first portion 22 is reinforced by a sheet metal or aluminum reinforcing strip or channel 34 to provide a firm and positive attachment of the first portion 22 of the molding 20 to the edge portion 18 of the windshield 10.

The extruded material forming the first portion 22 of the molding 20 preferably has a durometer within the range of 40D to 85D of the Shore D scale. The flange portion 26 is co-extruded with a layer 38 of a softer and more flexible plastics such as a PVC material or a TPE (Thermoplastic Elastone) or TPV (Thermoplastic Valcanite) having a durometer preferably within the range of 50A to 90A of the Shore A scale and an interface 39 with the harder material. This softer cap layer 38 is desirable when windshield wipers (not shown) travel from the windshield 10 onto the first portion 22 of the molding 20. The elongated molding 20 also includes a second body portion 42 which is extruded of the same plastics material as the first portion 22 and includes an upwardly projecting leg or flange portion 44 and a projection 46 which cooperate with a bottom flange portion 47 and the first portion 22 to define a longitudinally extending cavity 48. The second body portion 42 of the molding 20 is reinforced by an L-shaped sheet metal or aluminum reinforcing strip or member 49 to provide the second portion 42 of the molding 20 with substantial rigidity.

An elongated flexible and resilient tooth portion 50 is co-extruded with the first body portion 22 of the molding 20 of a softer and flexible or plastics material, such as the materials mentioned above for the layer 38 and preferably having a durometer within the range of 50A to 90A on the Shore A scale. The tooth portion 50 normally projects downwardly on an incline into the cavity 48 and is located in an opposing relation to the projection 46 on the flange portion 44 of the molding 20. The flexible tooth portion 50 has an interface 52 with the harder and more rigid material forming the first portion 22 of the molding 20 and has a rounded end surface 53.

An elongated cowl panel 55 is connected to the molding 20 and is preferably molded of a rigid plastics material such as rigid polypropylene. The panel 55 includes a cover portion 58 and a downwardly projecting barb or dart portion 60 having generally a V-shaped cross-sectional configuration and including an inclined cam surface 62 extending substantially perpendicular to an inclined retention surface 64. As shown in FIG. 1, after the cowl panel 55 is installed within the molding 20, the flexible tooth portion 50 normally opposes and is substantially perpendicular to the retention surface 64 on the dart portion 60 so that the dart portion is positively retained or secured within the cavity 48 while the cover portion 58 sits on the upper end of the leg or flange portion 44 of the second portion 42 of the molding 20. As also shown in FIG. 1, the second portion 42 is co-extruded with a softer base layer 68 of the same flexible plastics material as the tooth portion 50 and sits on a vehicle body panel 72. The base layer 68 has an interface 74 with the material forming the more rigid second portion 42 of the molding 20 and may include a rubber modifier or anti-itch material such as a PVC material sold under the trademark ALYCRN or a TPV material or a PVC or TPV material plus a rubber valcanite to avoid any squeaking noise during slight rubbing with the vehicle body panel 72.

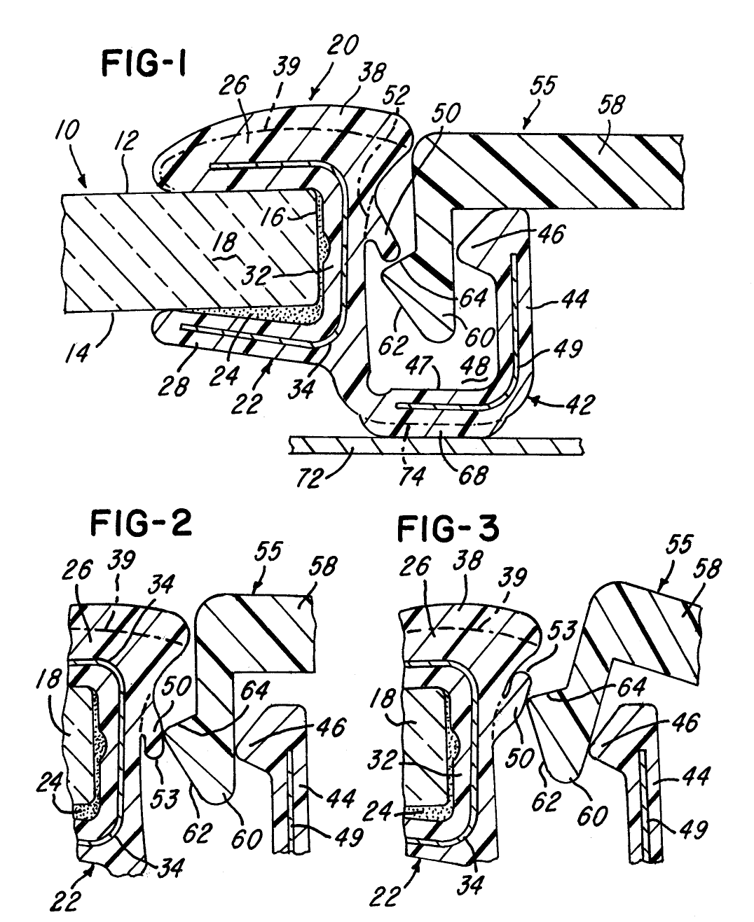

After the molding 20 is pre-assembled onto the edge portion 18 of the windshield 10 and the adhesive 24 cures, the pre-assembly is installed on the motor vehicle after which the cowl panel 55 is installed to the position shown in FIG. 1. As shown in FIG. 2, when the cowl panel 55 is being installed, the dart portion 60 is inserted through the throat defined between the projection 46 and the tooth portion 50 and into the cavity 48. The cam surface 62 flexes the tooth portion 50 downwardly against the web portion 32 of the molding. After the cowl panel 55 seats on the upper end of the flange portion 44 of the molding 20, the resilient tooth portion 50 flips back to its normal position (FIG. 1) where the tooth portion opposes in a generally perpendicular relation to the retention surface 64 on the dart portion 60. The cowl panel 55 is then positively locked or connected to the molding 20. The angle of the tooth portion 50 helps determine the forces required to insert and remove the cowl panel 55.

When it is desired to remove the cowl panel 55, the panel is pulled or peeled upwardly with a predetermined force which causes the resilient tooth portion 52 to fold or flex upwardly against the flange portion 26 of the molding 20, and the cowl panel is removed from the molding 20. The resiliency and flexibility of the tooth portion 50 determines the force required to remove the cowl panel across the width of the motor vehicle, and the durometer of the tooth portion may be selected and co-extruded to provide the desired insertion force and removal force for the dart portion 60.

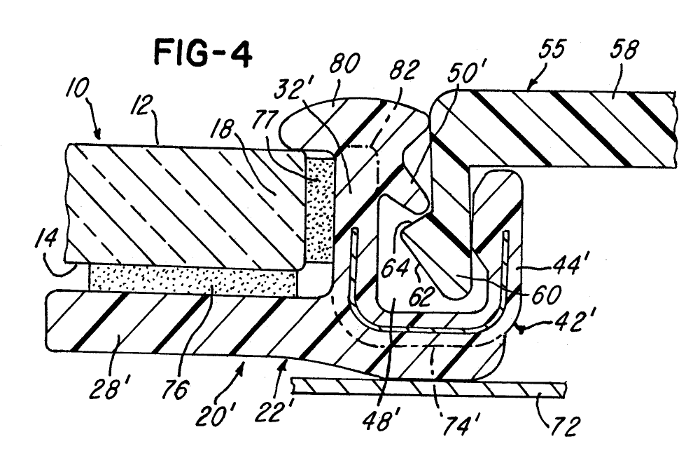

Referring to FIG. 4 which shows a modification of a molding constructed in accordance with the invention, a molding 20′ of extruded plastics materials, such as the materials mentioned above, includes a first body portion 22′ having a flexible flange portion 28′ with a durometer within the range of 50A to 90A on the Shore A scale and which extends to seat on the vehicle body panel 72. The molding 20′ also includes a second body portion 42′ extruded from a more rigid plastics material having an interface 74′ with the softer body portion 22′ and a durometer within the range of 40D to 85D on a Shore D scale. The second portion 42′ includes an outer leg or flange portion 44′ and an inner leg or flange portion 32′ and defines a cavity 48′. The edge portion 18 of the windshield 10 is attached to the molding 20′ by double-sided adhesive foam tape strips 76 and 77. The strip 76 attaches the inner surface 14 of the windshield to the flange portion 28′, and the strip 77 attaches the edge surface 16 of the windshield 10 to the flange portion 32′ of the second body portion 42′.

A cap portion 80 of PVC or TPE or TPV is co-extruded with the second body portion 42′ of the molding 20′ and preferably has a durometer within the range of 50A to 90A on a Shore A scale. The cap portion 80 has an interface 82 with the more rigid flange portion 32′ of the molding 20′. A flexible and resilient projection or tooth portion 50′ is extruded as a part of the cap portion 80 and normally projects downwardly into the cavity 48′ in opposing relation to the retention surface 64 on the dart portion 60 of the cowl panel 55. The resilient tooth portion 50′ functions in the same manner as the tooth portion 50 and flexes between the downwardly projecting position, such as shown in FIG. 2 and an upwardly projecting position, as shown in FIG. 3, in response to inserting and removing the dart portion 60 of the cowl panel 55.

From the drawings and the above description, it is apparent that a molding constructed in accordance with the invention for connecting and sealing a motor vehicle windshield to a motor vehicle cowl panel, provides desirable features and advantages. As a primary advantage, the angle or generally normal position and the flexibility of the resilient tooth portion 50 or 50′ of the molding 20 or 20′ provides for positively retaining the cowl panel 50 within the cavity 48 or 48′ while providing for precisely selecting the force required to insert the cowl panel and to remove the cowl panel. More specifically, the generally normal position of the tooth portion 50 or 50′ relative to the retention surface 64 on the dart portion 60 of the cowl panel provides the positive retention of the cowl panel along the entire length of the cowl panel across the width of the windshield. In addition, the angle and flexibility of the tooth portion, as determined by the durometer of the selected co-extruded plastics material, and the space above and below the tooth portion, determines the force required to insert the dart portion 60 into the cavity and to remove the dart portion of the cowl panel from the cavity. This force may be precisely selected by changing the durometer of the material forming the tooth portion or the angle of the tooth portion. The softer material of the co-extruded cap layer 38 or cap portion 80 also permits windshield wipers to move or glide smoothly from the outer surface 12 of the windshield 10 over to the outer or top surface of the cowl panel 55 without wearing the windshield blades when it is desired to rest or park the windshield wiper blades on the cowl panel.

While the forms of molding herein described constitute preferred embodiments of the invention, it is to be understood that the invention is not limited to these precise forms of the invention, and that changes made therein without departing from the scope and spirit of the invention as defined in the appended claims.

What is claimed is:

1. A molding forming a seal between a windshield of a motor vehicle and an adjacent cowl panel attached to the motor vehicle, comprising
said windshield having an inner surface and a parallel outer surface connected by an outer edge surface,
said cowl panel including an outer cover portion and a dart portion projecting downwardly from said cover portion,
said dart portion having a cam surface extending from a retention surface,
said molding comprising an elongated body of extruded plastics material and including a first portion attached to said windshield and a second portion defining a longitudinally extending cavity receiving said dart portion of said cowl panel,
said body including a longitudinally extending flexible tooth portion of resilient plastics material and projecting in a generally normal position towards said retention surface on said dart portion of said cowl panel, and
said flexible tooth portion being flexible from said normal position to a downwardly projecting position in response to inserting said dart portion of said cowl panel into said cavity and to an upwardly projecting position in response to removing said dart portion from said cavity.

2. A molding as defined in claim 1 wherein said flexible tooth portion projects downwardly on an incline into said cavity in said normal position and is generally perpendicular to said retention surface on said dart portion of said cowl panel.

3. A molding as defined in claim 1 wherein said first portion of said body is channel-shaped and extends adjacent said first surface, said second surface and said edge surface of an edge portion of said windshield, and adhesive bonding said first portion to at least one said surface of said windshield.

4. A molding as defined in claim 3 wherein said first portion of said body includes an embedded metal reinforcement channel, and said second portion of said body includes an embedded metal reinforcement member having a L-shape cross-sectional configuration.

5. A molding as defined in claim 1 wherein said first portion of said body comprises a flange portion adhesively bonded to said inner surface of said windshield, and said second portion of said body is generally U-shape in cross-section and is adhesively bonded to said edge surface of said windshield.

6. A molding as defined in claim 5 wherein said second portion of said body includes an embedded elongated U-shape metal reinforcement channel.

7. A molding as defined in claim 1 wherein said second portion of said body includes a substantially rigid portion generally opposing said flexible tooth portion and defining a space therebetween for inserting said dart portion of said cowl panel into said cavity.

8. A molding as defined in claim 1 wherein said retention surface on said dart portion of said cowl panel is generally perpendicular to said flexible tooth portion.

9. A molding as defined in claim 1 wherein said plastics material forming said second portion of said body has a durometer within the range 40D to 85D on a Shore D scale, and said plastics material forming said tooth portion has a durometer within the range of 50A to 90A on a Shore A scale.

10. A molding as defined in claim 1 wherein said second portion of said body includes an integrally connected and co-extruded cap portion projecting above said outer surface of said windshield and having a top surface generally flush with a top surface of said cover portion of said cowl panel.

11. A molding as defined in claim 10 wherein said cap portion and said flexible tooth portion are each co-extruded of a plastics material having a durometer within the range of 50A to 90A on a Shore A scale.

12. A molding forming a seal between a windshield of a motor vehicle and an adjacent cowl panel attached to the motor vehicle, comprising
said windshield having an inner surface and a parallel outer surface connected by an outer edge surface,
said cowl panel including an outer cover portion and a dart portion projecting downwardly from said cover portion,
said dart portion having a generally V-shaped cross-sectional configuration with a cam surface extending from a retention surface,
said molding comprising an elongated body formed by an extrusion of substantially rigid plastics material and including a first portion attached to said windshield and a second portion defining a longitudinally extending cavity receiving said dart portion of said cowl panel,
said body including a co-extruded flexible tooth portion of resilient plastics material and projecting in a generally normal position towards said retention surface on said dart portion of said cowl panel, and
said tooth portion being flexible from said normal position to a downwardly projecting position in response to inserting said dart portion of said cowl panel into said cavity and to an upwardly projecting position in response to removing said dart portion from said cavity.

13. A molding as defined in claim 12 wherein said flexible tooth portion projects downwardly on an incline into said cavity in said normal position and is generally perpendicular to said retention surface on said dart portion of said cowl panel.

14. A molding as defined in claim 12 wherein said first portion of said body is channel-shaped and extends adjacent said first surface, said second surface and said edge surface of an edge portion of said windshield, and adhesive bonding said first portion to at least one said surface of said windshield.

15. A molding as defined in claim 14 wherein said first portion of said body includes an embedded sheet metal reinforcement channel, and said second portion of said body includes an embedded sheet metal reinforcement member having a L-shape cross-sectional configuration.

16. A molding as defined in claim 12 wherein said first portion of said body comprises a flange portion adhesively bonded to said inner surface of said windshield, and said second portion of said body is generally U-shape in cross-section and is adhesively bonded to said edge surface of said windshield.

17. A molding as defined in claim 12 wherein said second portion of said body includes a substantially rigid portion generally opposing said flexible tooth portion and defining a space therebetween for inserting said dart portion of said cowl panel into said cavity.

18. A molding as defined in claim 12 wherein said plastics material forming said tooth portion has a durometer within the range of 50A to 90A on a Shore A scale.

19. A molding as defined in claim 12 wherein said second portion of said body includes an integrally connected and co-extruded cap portion projecting above said outer surface of said windshield and having a top surface generally flush with a top surface of said cover portion of said cowl panel.

20. A molding as defined in claim 19 wherein said cap portion and said flexible tooth portion are each co-extruded of a plastics material having a durometer within the range of 50A to 90A on a Shore A scale.
